(19) United States
(12) Patent Application Publication
(10) Pub. No.: US 2006/0158484 A1
(43) Pub. Date: Jul. 20, 2006

(54) Thermal actuator for a MEMS device

(76) Inventor: Dennis S. Greywall, Whitehouse Station, NJ (US)

Correspondence Address: MENDELSOHN & ASSOCIATES, P.C., 1500 JOHN F. KENNEDY BLVD., SUITE 405, PHILADELPHIA, PA, 19102, US

(21) Appl. No.: 11/036,264

(22) Filed: Jan. 14, 2005

(51) Int. Cl. B41J 2/05

(52) U.S. Cl. 347/56

(57) ABSTRACT

A MEMS device having a fixed-fixed flexible beam, which is adapted to produce mechanical movement in response to a change of a temperature gradient and is relatively insensitive to variations in ambient temperature. In one embodiment, the flexible beam is connected between two support structures affixed to a substrate such that thermal deformation causes the beam to produce a displacement of its middle portion, thereby generating motion of a structure connected to that portion. In one embodiment, the structure includes (i) a plate having an IR-absorbing layer, which can transfer heat from IR radiation to the flexible beam, and (ii) an electrode layer, which together with a stationary electrode attached to the substrate forms a variable capacitor. Changes in the capacitance of the variable capacitor can be detected and related to the temperature of the IR-absorbing layer and/or intensity of the IR radiation impinging upon that layer.

### BACKGROUND OF THE INVENTION

1. Field of the Invention

The present invention relates to optical imaging systems and, more specifically, to micro-electromechanical systems (MEMS) for implementing such imaging systems.

2. Description of the Related Art

FIGS. 1A-B show side cross-sectional views of a prior-art MEMS-based, infrared (IR) sensor 100. Sensor 100 has a cantilever plate 110, which is connected at one end to a support structure 120 affixed to a substrate 102. Plate 110 includes three layers of material: a gold layer 112, a Ti/W layer 114; and an amorphous hydrogenated silicon carbide layer 116. Ti/W layer 114 forms part of an IR-absorbing cavity, which absorbs IR radiation. Ti/W layer 114 is in good thermal contact with both gold layer 112 and amorphous hydrogenated silicon carbide layer 116. The materials of layers 112 and 116 are chosen such that they react to the heat received from layer 114 by inducing mechanical movement of plate 110. More specifically, gold and amorphous hydrogenated silicon carbide have a relatively large difference in the values of their thermal expansion coefficients. When the temperature of plate 110 is elevated due to IR irradiation of the plate, layers 112, 114, and 116 expand in accordance with the values of their respective thermal expansion coefficients. However, because the layers adhere to one another, tensile and compressive stresses are generated in amorphous hydrogenated silicon carbide layer 116 and gold layer 112, respectively. The difference in stresses results in a stress gradient, which causes plate 110 to bend as shown in FIG. 1B.

Plate 110 and an electrode 104 buried in substrate 102 form a capacitor 108, which is used to detect the deformation of the plate. More specifically, capacitor 108 is connected to a circuit 130 adapted to measure capacitance. Circuit 130 measures the capacitance of capacitor 108 by comparing it with that of a reference capacitor (not shown). The measured difference in the capacitance values can then be related to the deformation amplitude and therefore the temperature of plate 110.

One problem with sensor 100 is related to its relatively high sensitivity to variations in ambient temperature. More specifically, if the ambient temperature deviates from an intended operating temperature by a relatively large amount, e.g., during shipment or storage, plate 110 is deformed and might touch and stick to substrate 102 or electrode 104, thereby rendering sensor 100 inoperable. Another problem with sensor 100 is related to its fabrication. More specifically, it is often difficult to form layers of materials having disparate thermal expansion properties in contact with one another such that the built-in residual stresses in these layers are relatively low. As a result, plate 110 may have a distorted shape similar to that shown in FIG. 1B even in the absence of IR radiation. In addition, a sensor array having a plurality of sensors 100 typically suffers from an unpredictable variation of plate shapes across the array due to a difficult-to-control variation in the built-in residual stresses from plate to plate.

### SUMMARY OF THE INVENTION

Various embodiments address problems in the prior art by a MEMS device having a fixed-fixed flexible beam, which is adapted to produce mechanical movement in response to a change of a temperature gradient and is relatively insensitive to variations in ambient temperature.

In one embodiment, the flexible beam is connected between two support structures affixed to a substrate such that thermal deformation causes the beam to produce a displacement of its middle portion, thereby generating motion of a structure connected to that portion. In one embodiment, the structure includes (i) a plate having an IR-absorbing layer, which can transfer heat from IR radiation to the flexible beam, and (ii) an electrode layer, which together with a stationary electrode attached to the substrate forms a variable capacitor. Changes in the capacitance of the variable capacitor can be detected and related to the temperature of the IR-absorbing layer and/or intensity of the IR radiation impinging upon that layer.

Advantageously, some embodiments can be relatively insensitive to variations in ambient temperature because, in a first order approximation, uniform heating of the entire device does not generate any significant displacement in the flexible beam. In addition, various embodiments can have (i) a relatively simple structure providing for relative ease of fabrication; (ii) a relatively high fill factor in an array; and/or (iii) relatively high sensitivity to IR radiation.

### BRIEF DESCRIPTION OF THE DRAWINGS

Other aspects, features, and benefits of the present invention will become more fully apparent from the following detailed description, the appended claims, and the accompanying drawings in which:

FIGS. 1A-B show side cross-sectional views of a prior-art MEMS-based IR sensor;

FIGS. 2A-B show side cross-sectional views of a thermal actuator according to one embodiment;

FIG. 3 shows a three-dimensional perspective view of a MEMS-based IR sensor according to one embodiment;

FIG. 4 shows a three-dimensional perspective view of a MEMS device according to one embodiment;

FIGS. 5A-B show top views of a thermal actuator according to another embodiment;

FIGS. 6A-B show top views of a MEMS-based IR sensor according to another embodiment; and

FIG. 7 shows a top view of an electrode that can be used in a sensor analogous to the sensor shown in FIG. 6 according to one embodiment.

### DETAILED DESCRIPTION

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments.

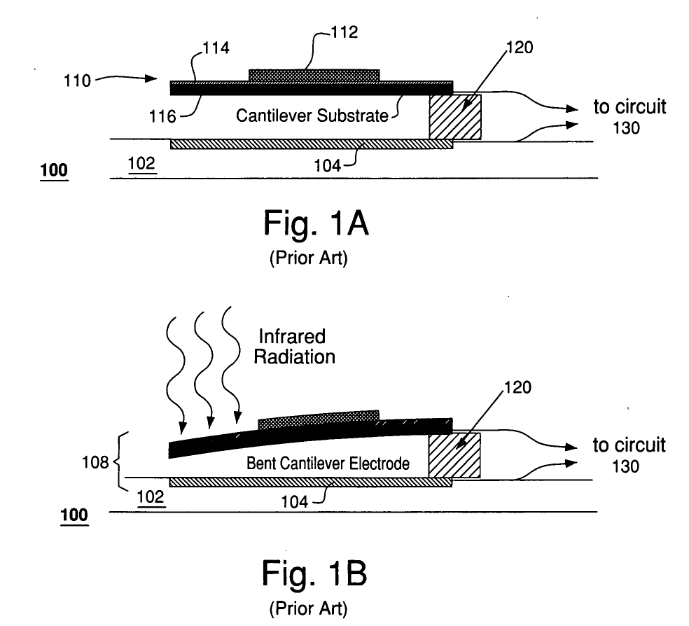

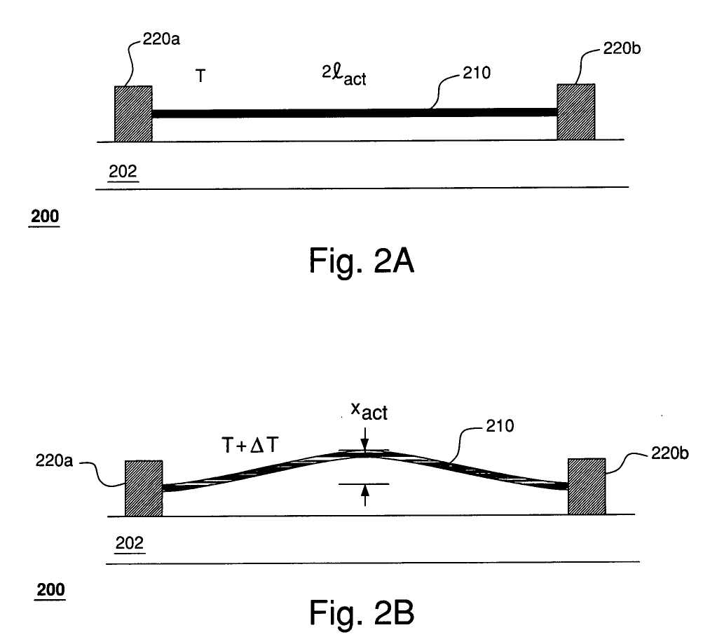

FIGS. 2A-B show side cross-sectional views of a thermal actuator 200 according to one embodiment. Similar to plate 110 of sensor 100 (FIG. 1), actuator 200 is designed to convert heat into mechanical movement. However, the principle of operation for actuator 200 is different from that of plate 110 and does not rely upon adjoining layers of materials having disparate thermal expansion properties.

Actuator 200 has a flexible beam 210, which is attached between two support structures 220a-b affixed to a substrate 202. This beam configuration is often referred to in the relevant literature as a fixed-fixed beam. At temperature T, beam 210 has a first shape, e.g., a straight shape shown in FIG. 2A. When the temperature of beam 210 is elevated by ΔT with respect to that of substrate 202, the length of beam 210 increases due to thermal expansion. However, because the substrate remains at temperature T and does not similarly expand, the distance between support structures 220a-b remains substantially unchanged. As a result, the thermal expansion causes beam 210 to buckle, e.g., as shown in FIG. 2B, and adopt a second shape. This second shape can be approximated by a sine function and the beam's midpoint displacement, x_{act}, can be estimated using Eq. (1) as follows:

$$\frac{{x}_{act}}{{l}_{act}} \approx 1.8 \sqrt{αΔ T} \qquad ( 1 )$$

where α is the thermal expansion coefficient of the beam's material and 2l_{act} is the beam length at temperature T. To summarize, whenever there is a change in the temperature gradient within actuator 200 (said gradient resulting, e.g., from a temperature difference between substrate 202 and beam 210, and represented by the term ΔT in Eq. (1)), there is also a corresponding change in the shape of beam 210 leading to a change of x_{act}.

Different methods can be used to heat beam 210 in actuator 200. For example, in one embodiment, beam 210 can be resistively heated by passing electrical current through the beam. In another embodiment, beam 210 can be placed in thermal contact with a heat absorber (not shown), which can be heated by receiving IR radiation similar to Ti/W layer 114 in sensor 100 or by any other suitable means.

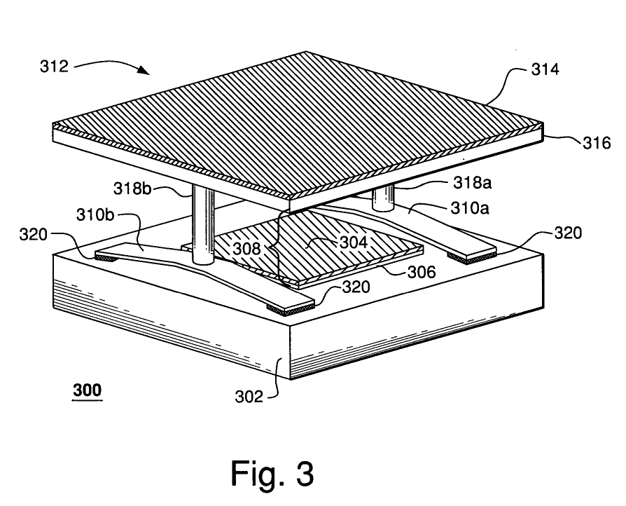

FIG. 3 shows a three-dimensional perspective view of a MEMS-based IR sensor 300 according to one embodiment. Sensor 300 has two thermal actuators analogous to thermal actuator 200 of FIG. 2. More specifically, each of the two thermal actuators of sensor 300 includes a flexible beam 310, which is attached between two support structures 320 affixed to a substrate 302. However, one difference between beam 310 of sensor 300 and beam 210 of actuator 200 is that, unlike beam 210, beam 310 has a slightly arched shape at the intended operating temperature even in the absence of IR irradiation. The arched shape of beam 310 removes an uncertainty with respect to the buckling direction inherent to the straight shape of beam 210. More specifically, due to a plane of symmetry for beam 210 in actuator 200, which plane is parallel to the plane of substrate 202, the beam has substantially equal probabilities to buckle in the outward direction with respect to the substrate as shown in FIG. 2B or to buckle toward the substrate. The curved shape of beam 310 does not have such a plane of symmetry, thereby removing the uncertainty with respect to the buckling direction and causing the beam to buckle outward with respect to substrate 302.

Sensor 300 further has a plate 312 connected to beams 310a-b by rods 318a-b, respectively. In one embodiment, plate 312 includes two layers of material: an IR-absorbing layer 314 and an electrode layer 316. When layer 314 is subjected to IR irradiation, the temperature of plate 312 rises. Due to the thermal contact between plate 312 and beams 310a-b provided by rods 318a-b, heat is transferred to the beams causing them to buckle, thereby moving the plate.

To detect motion of plate 312, sensor 300 has an electrode 304 attached to substrate 302 and electrically insulated from the substrate by a dielectric layer 306. Electrode 304 and electrode layer 316 of plate 312 form a parallel-plate capacitor 308 whose capacitance depends on the distance between the plate and the electrode. As such, change in the relative position of plate 312 can be measured by measuring the capacitance of capacitor 308, e.g., using a detection circuit (not shown) analogous to circuit 130 of sensor 100 (FIG. 1). The measured capacitance can then be related to the temperature of plate 312 and/or intensity of the IR radiation impinging upon the plate. In one embodiment, substrate 302 incorporates a buried electrode (not shown), which together with electrode 304 forms a reference capacitor for the detection circuit. Representative detection circuits for measuring changes in capacitance include circuits described in a paper by S. R. Hunter et al., published in the Proceedings of SPEE, vol. 5074, pp. 469-480, the teachings of which are incorporated herein by reference. One skilled in the art will also understand that other detection circuits or methods can similarly be used in sensor 300 as appropriate or necessary.

In one embodiment, sensor 300 can be fabricated using the following set of materials: (i) amorphous hydrogenated silicon carbide for substrate 302, beams 310, rods 318, electrode layer 316 and electrode 304; (ii) silicon oxide for dielectric layer 306 and support structures 320; and (iii) Ti/W for layer 314. In another embodiment, sensor 300 can be fabricated using silicon for substrate 302, beams 310, rods 318, electrode layer 316 and electrode 304. One skilled in the art will appreciate that other appropriate materials can similarly be used.

In one embodiment, sensor 300 has the following dimensions: (i) between about 10 to a few hundred microns for the length and width plate 312 and the length of beam 310; (ii) between about 1 and 5 micron for the width of beam 310; (iii) about 0.5 micron for the gap between electrode 304 and plate 312; (iv) between about 0.1 and 0.5 micron for the thickness of beam 310; (v) about 0.1 micron for the thickness of layer 314; and (vi) about 1 micron for the thickness of plate 312.

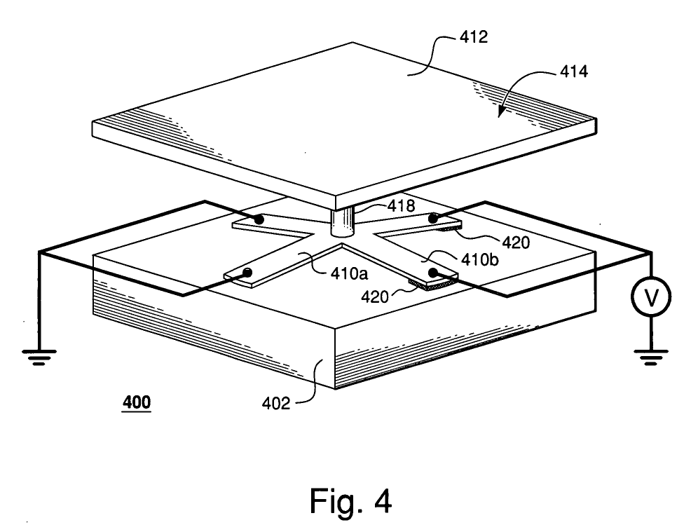

FIG. 4 shows a three-dimensional perspective view of a MEMS device 400 according to one embodiment. Device 400 has a thermal actuator analogous to that of sensor 300 of FIG. 3. More specifically, the thermal actuator of device 400 has two crossed flexible beams 410a-b, each of which is analogous to flexible beam 310 of sensor 300. Device 400 also has a plate 412 connected to beams 410a-b by a rod 418 as shown in FIG. 4. A first end of each beam 410 is attached directly to a substrate 402, while a second end of each beam is attached to a corresponding support structure 420 affixed to the substrate. Since support structures 420 electrically isolate the second ends of beams 410a-b from substrate 402 while the first ends of these beams are in direct electrical contact with the substrate, the second ends can be electrically biased with respect to the first ends, e.g., as shown in FIG. 4. When a voltage differential is applied between the ends of beams 410a-b, an electrical current flows through the beams, thereby resistively heating the beams and causing them to buckle and move plate 412 with respect to the substrate. By regulating the voltage differential applied to beams 410a-b, the amount of displacement for plate 412 can be appropriately regulated.

In one embodiment, plate 412 has a reflective surface 414 adapted to reflect light impinging upon the plate. Accordingly, device 400 can be used to form an arrayed device having a segmented mirror, wherein plates 412 of individual devices 400 serve as segments of the segmented mirror. In one configuration, the segmented mirror of the arrayed device can be used in a spatial light modulator for adaptive optics applications or optical maskless lithography.

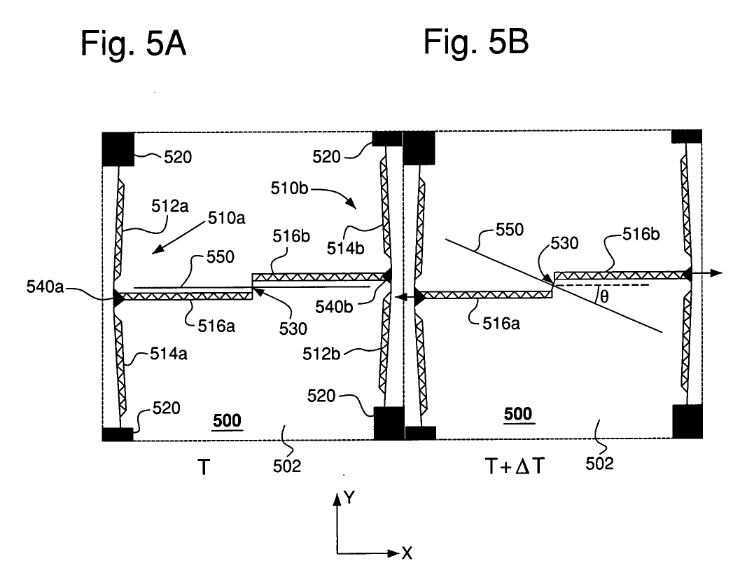

FIGS. 5A-B show top views of a thermal actuator 500 according to another embodiment. Similar to actuator 200 of FIG. 2, actuator 500 is designed to convert changes in temperature gradients into mechanical movement. However, one difference between actuators 200 and 500 is that the former is primarily adapted to generate translation with respect to the substrate, while the latter is adapted to generate rotation about an axis perpendicular to the plane of the substrate. Actuator 500 includes two T-shaped beam arrangements 510a-b connected by a deformable linker 530. Each beam arrangement 510 includes three beams 512, 514, and 516. Beams 512 and 514 are joined together at a flexible linker 540 and connected between two corresponding support structures 520, each of which is attached to a substrate 502, and beam 516 is connected between linkers 530 and 540.

FIG. 5A depicts actuator 500 at temperature T, at which an optional indicator needle 550 connected to linker 530 is oriented parallel to the X-axis. When the temperature of arrangements 510a-b is elevated to T+αT, e.g., by IR irradiation or resistive heating, beams 512a-b and 514a-b buckle outwards as shown by the arrows in FIG. 5B, thereby causing each of beams 516a-b to pull on linker 530. As a result of this pull, linker 530 is deformed and reoriented, causing needle 550 to rotate by angle θ with respect to the needle orientation shown in FIG. 5A.

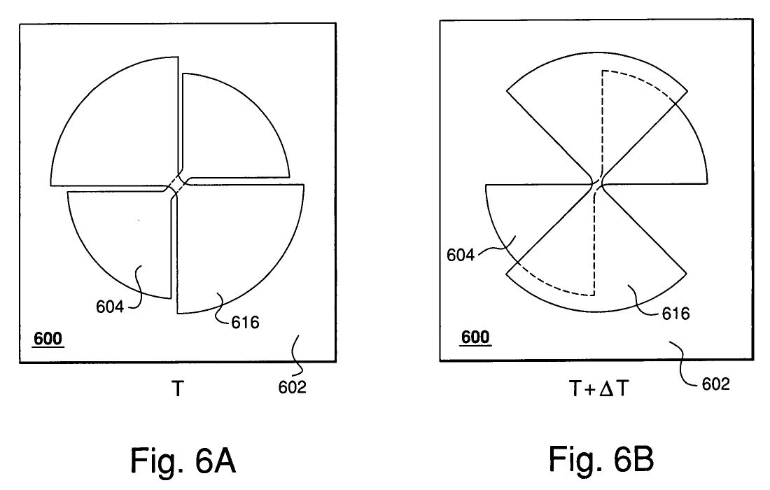

FIGS. 6A-B shows top views of a MEMS-based IR sensor 600 according to another embodiment. Sensor 600 includes (i) a thermal actuator (not shown) analogous to actuator 500 of FIG. 5, (ii) a movable electrode 616 attached to an underlying linker (not shown) of the thermal actuator analogous to linker 530 of actuator 500, and (iii) a stationary electrode 604 attached to a substrate 602. Due to the physical attachment, deformation and reorientation of linker 530 causes the rotation of electrode 616 as illustrated in FIGS. 6A-B.

Each of movable electrode 616 and stationary electrode 604 has a shape of two sectors connected by a narrow bridge. FIG. 6A depicts sensor 600 at temperature T, at which electrodes 616 and 604 are oriented with respect to one another such that their sectors substantially do not overlap. As a result, a capacitor formed by electrodes 616 and 604 has a relatively low capacitance. When the temperature of the beams in the thermal actuator is elevated to T+ΔT, e.g., by IR irradiation, the thermal actuator causes movable electrode 616 to rotate similar to indicator needle 550 in actuator 500. As shown in FIG. 6B, in a rotated position, electrodes 616 and 604 have a substantial overlap, which causes the capacitor to have a relatively large capacitance. This increase in the capacitance can be detected and related to ΔT, e.g., as already described above.

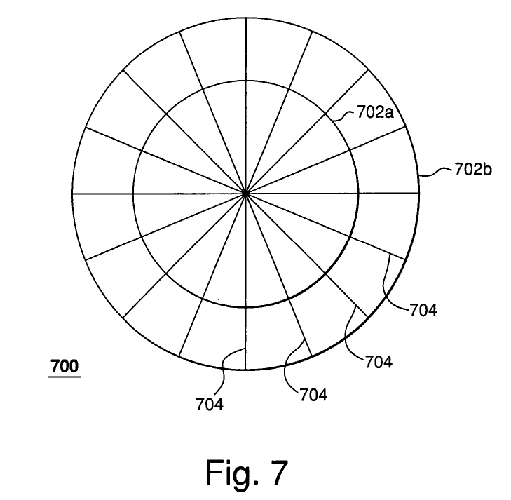

FIG. 7 shows a top view of an electrode 700 that can be used in a sensor analogous to sensor 600 (FIG. 6) according to one embodiment. Electrode 700 is a grid structure formed by two circular beams 702a-b and 16 radial beams 704 (with voids between the beams), which structure can be used to significantly increase the sensor sensitivity to small temperature changes. For example, suppose that the sensor has concentric movable and stationary electrodes, each shaped as electrode 700, but having different diameters. Suppose also that, at temperature T, the electrodes are oriented with respect to one another such that their radial beams do not overlap. Since the electrodes have different diameters, the circular beams also do not overlap. Due to the lack of overlap, the capacitor formed by the movable and stationary electrodes has a relatively low capacitance. However, when the temperature of the beams in the thermal actuator is elevated to T+ΔT, the movable electrode rotates past one or more positions in which the radial beams of the two electrodes do overlap (are collinear). When the radial beams are collinear, the capacitance increases by a relatively large amount. Therefore, rotation of the movable electrode generates a relatively large-amplitude modulation of the capacitance, which can be used to generate a relatively strong, pulsed signal even at relatively small rotation angles.

Various embodiments may have one or more of the following advantages over prior-art devices (e.g., sensor 100 of FIG. 1). A representative embodiment is relatively insensitive to variations in ambient temperature because, in a first order approximation, uniform heating of the entire device does not generate any displacement of a flexible beam similar to beam 210 of thermal actuator 200. In addition, various embodiments may have (i) a relatively simple structure providing for relative ease of fabrication; (ii) a relatively high fill factor in an array; and/or (iii) relatively high sensitivity to IR radiation.

Various embodiments may be fabricated, as known in the art, using layered wafers having, e.g., silicon, silicon oxide, amorphous hydrogenated silicon carbide, IR-absorbing, and metal layers. Additional layers of material may be deposited onto a wafer using, e.g., chemical vapor deposition. Various parts of the devices may be mapped onto the corresponding layers using lithography, gray-scale masks, and/or reflow of patterned resist. The devices may incorporate inter-layer vias, which provide appropriate grounding and/or electrical contacts, and service openings, which provide etchant access to the sacrificial layer(s) during fabrication. Additional description of various fabrication steps may be found, e.g., in U.S. Pat. Nos. 6,201,631, 5,629,790, and 5,501,893, the teachings of which are incorporated herein by reference.

While this invention has been described with reference to illustrative embodiments, this description is not intended to be construed in a limiting sense. Various surfaces may be modified, e.g., by metal deposition for enhanced reflectivity and/or electrical conductivity, or by deposition of a material adapted to absorb electromagnetic radiation, or by ion implantation for enhanced mechanical strength. Differently shaped mirrors, plates, rods, beams, actuators, and/or electrodes may be implemented without departing from the scope and principle of the invention. More than two support structures may be used to implement a fixed-fixed beam. Various embodiments of MEMS devices may be arrayed as necessary and/or apparent to a person skilled in the art. An arrayed MEMS device of the invention can be designed for use in an adaptive optics application, a maskless lithography application, and/or an IR-sensing/imaging application, or other suitable applications. Sensors of the invention can similarly be adopted to be sensitive to radiation other than IR radiation. Various modifications of the described embodiments, as well as other embodiments of the invention, which are apparent to persons skilled in the art to which the invention pertains are deemed to lie within the principle and scope of the invention as expressed in the following claims.

For the purposes of this specification, a MEMS device is a device having two or more parts adapted to move relative to one another, where the motion is based on any suitable interaction or combination of interactions, such as mechanical, thermal, electrical, magnetic, optical, and/or chemical interactions. MEMS devices are fabricated using micro- or smaller fabrication techniques (including nano-fabrication techniques) that may include, but are not necessarily limited to: (1) self-assembly techniques employing, e.g., self-assembling monolayers, chemical coatings having high affinity to a desired chemical substance, and production and saturation of dangling chemical bonds and (2) wafer/material processing techniques employing, e.g., lithography, chemical vapor deposition, patterning and selective etching of materials, and treating, shaping, plating, and texturing of surfaces. The scale/size of certain elements in a MEMS device may be such as to permit manifestation of quantum effects. Examples of MEMS devices include, without limitation, NEMS (nano-electromechanical systems) devices, MOEMS (micro-opto-electromechanical systems) devices, micromachines, Microsystems, and devices produced using microsystems technology or Microsystems integration.

Although the present invention has been described in the context of implementation as MEMS devices, the present invention can in theory be implemented at any scale, including scales larger than micro-scale.

Although the steps in the following method claims, if any, are recited in a particular sequence with corresponding labeling, unless the claim recitations otherwise imply a particular sequence for implementing some or all of those steps, those steps are not necessarily intended to be limited to being implemented in that particular sequence.

What is claimed is:

1. Apparatus, comprising a MEMS device, which includes one or more flexible beams, each connected between at least two support structures affixed to a substrate, wherein, for each beam:
at a first temperature gradient, the beam has a first shape; and
at a second temperature gradient different from the first temperature gradient, thermal deformation causes the beam to adopt a second shape different from the first shape, wherein a portion of the beam is displaced with respect to a position corresponding to the first shape.

2. The invention of claim 1, wherein at least one flexible beam is adapted to be resistively heated to produce the temperature gradient change.

3. The invention of claim 1, wherein at least one flexible beam is adapted to be heated by radiation to produce the temperature gradient change.

4. The invention of claim 1, wherein the device further comprises a plate connected to the one or more flexible beams, wherein the temperature gradient change results in motion of the plate with respect to the substrate.

5. The invention of claim 4, wherein the plate has a layer adapted to absorb radiation to produce the temperature gradient change.

6. The invention of claim 4, wherein:
the plate has an electrode layer; and
the device further comprises a stationary electrode attached to the substrate, wherein the motion of the plate produces a capacitance change for a capacitor formed by the electrode layer and the stationary electrode.

7. The invention of claim 6, wherein the device further comprises a circuit adapted to detect the capacitance change.

8. The invention of claim 6, wherein:
the electrode layer comprises a first grid structure; and
the stationary electrode comprises a second grid structure, wherein the first and second grid structures are located with respect to one another such that the motion of the plate generates a pulsed modulation of the capacitance.

9. The invention of claim 8, wherein:
each of the grid structures comprises one or more circular beams connected to a plurality of radial beams; and
the first and second grid structures have different sizes.

10. The invention of claim 6, wherein:
in a first position corresponding to the first temperature gradient, the electrode layer does not substantially overlap with the stationary electrode; and
in a second position corresponding to the second temperature gradient, the electrode layer has substantial overlap with the stationary electrode, thereby generating an increase in the capacitance.

11. The invention of claim 4, wherein:
the one or more flexible beams comprise first and second flexible beams; and
the plate is connected to the first and second flexible beams such that the motion is translation with respect to the substrate.

12. The invention of claim 4, wherein:
the one or more flexible beams form two arrangements connected by a flexible linker; and
the movable plate is connected to the flexible linker such that the motion is rotation with respect to the substrate.

13. The invention of claim 12, wherein the rotation is a rotation about an axis oriented substantially orthogonally to a plane of the substrate.

14. The invention of claim 4, wherein the one or more flexible beams comprise first and second flexible beams connected together in an X-shaped arrangement.

15. The invention of claim 1, wherein the flexible beam has an arched shape adopted to control the displacement direction.

16. The invention of claim 1, wherein the device is a part of an array having a plurality of such devices.

17. The invention of claim 1, wherein the device comprises amorphous hydrogenated silicon carbide and silicon oxide.

18. A method of generating mechanical movement, comprising:
changing temperature of one or more flexible beams, each connected between at least two support structures affixed to a substrate, with respect to the substrate temperature, wherein, for each beam:
at a first temperature gradient, the beam has a first shape; and
at a second temperature gradient different from the first temperature gradient, thermal deformation causes the beam to adopt a second shape different from the first shape, wherein a portion of the beam is displaced with respect to a position corresponding to the first shape, wherein the one or more flexible beams, the support structures, and the substrate are parts of a MEMS device.

19. The invention of claim 18, wherein:
the temperature change generates motion, with respect to the substrate, of a plate connected to the one or more flexible beams;
the plate has an electrode layer; and
the method further comprises detecting a capacitance change for a capacitor formed by the electrode layer and a stationary electrode attached to the substrate, said capacitance change produced by the motion of the plate.

20. Apparatus, comprising a MEMS device, which includes:
means for generating mechanical movement, wherein said means for generating include one or more flexible beams, each connected between at least two support structures affixed to a substrate; and
means for changing temperature of the one or more flexible beams with respect to the substrate temperature, wherein, for each beam:
at a first temperature gradient, the beam has a first shape; and
at a second temperature gradient different from the first temperature gradient, thermal deformation causes the beam to adopt a second shape different from the first shape, wherein a portion of the beam is displaced with respect to a position corresponding to the first shape.
